(19) United States
(12) Patent Application Publication
(10) Pub. No.: US 2009/0071279 A1
(43) Pub. Date: Mar. 19, 2009

(54) ADJUSTMENT DRIVE

(75) Inventor: Thomas HUCK, Rheinmuenster (DE)

Correspondence Address: MERCHANT & GOULD PC, P.O. BOX 2903, MINNEAPOLIS, MN, 55402-0903, US

(73) Assignee: Robert Bosch GmbH, Stuttgart (DE)

(21) Appl. No.: 12/211,590

(22) Filed: Sep. 16, 2008

(30) Foreign Application Priority Data
Sep. 17, 2007 (DE) 10 2007 044 350.3

(51) Int. Cl. F16H 1/16

(52) U.S. Cl. 74/425

(57) ABSTRACT

The invention relates to an adjustment drive, particularly a window actuating drive in a motor vehicle, with a gearing worm capable of being driven by an electric motor. Said gearing worm is situated in mesh with a first worm gear. Provision is made according to the invention for at least a second worm gear to be situated in mesh with the gearing worm.

### TECHNICAL FIELD

The invention relates to an adjustment drive, particularly a window adjustment drive in a motor vehicle according to the preamble of claim 1.

### BACKGROUND

With regard to adjustment drives being employed today for adjusting a window in a motor vehicle, the drive being used consists of a gearing worm, which can be actuated by an electric motor, and a worm gear, which meshes with the gearing worm. The worm gear is thereby for the most part configured as a plastic helical gear, and the gearing worm is configured from metal. It is important with regard to such adjustment drives that the worm drive consisting of the gearing worm and the worm gear has a strong gear-tooth construction because the gearing has to execute adjustment cycles during operation over its entire useful life. Particularly the adjustment drives used for adjusting windows in motor vehicles are exposed to large stresses, which can lead to gear tooth deformations over the useful life of the drive. Such deformed gear teeth can then move only within certain limits. In the case of an adjustment drive for a window in a motor vehicle, the large stresses result from among other things the fact that the window is moved against a limit stop at the end of an adjustment cycle. In so doing, the movement abruptly decelerates, which leads to a large stress on the gearing between the gearing worm and the worm gear when the drive torque of the electric motor is at a maximum. As a result of the abrupt deceleration, large dynamic forces additionally act on the gearing. Moreover, because the system consisting of the window and the adjustment drive frequently remains in the stop position over an extended period of time, a constant static stress on the gearing thereby results. Due to the fact that the plastic gears being employed can be subject to a so-called creep, a deformation of the plastic teeth of the worm gear with negative consequences can also arise from this type of stress.

Moreover, a strong gear-tooth construction is particularly important with regard to the electronic motors being used today, which, for example, implement the function “pinch protection” because changes in speed, which are caused by meshing errors or gear tooth deformations, can impair the function “pinch protection”.

The task underlying the invention is therefore to propose an adjustment drive, which can better withstand the stresses during operation.

### SUMMARY

This task is solved by an adjustment drive with the characteristics of claim 1. Advantageous modifications of the invention are stated in the sub-claims. Also all of the combinations of at least two of the characteristics, which are disclosed in the description, the claims and/or the figures, fall within the scope of the invention.

The idea behind the invention is to thereby increase the strength of the gearing of an adjustment drive; in that in addition to the first worm gear meshing with the gearing worm, provision is made for at least a second worm gear meshing with the gearing worm. In so doing, both worm gears are preferably configured as helical gears out of plastic. The basic concept of an adjustment drive allows for the stress to be relieved on the gear-tooth engagement between the first worm gear and the gearing worm in the different modifications, which are still to be explained below, whereby the operational reliability of the adjustment drive can be maintained over an extended period of time. Moreover, due to the improved strength of the gearing, the worm gears can be reduced in size when the gear ratio remains constant, whereby the installation space for an adjustment drive configured according to the concept of the invention can be minimized. The following advantages can be realized with an adjustment drive configured according to the concept of the invention: an adjustment drive, which is simple to install and can be cost effectively produced, with a comparatively small creeping tendency of the worm gears, which are to be used, is achieved; and in so doing, it lies within the scope of the invention for the worm gears to be configured, for example, from metal rather than plastic. The small creeping tendency is thereby to be attributed to the power distribution, respectively torque distribution, on at least two gearings engaging with the gearing worm. Moreover, the strength of the worm drive of the adjustment drive is increased and only slight elastic tooth deformations of the worm gears occur, if at all, which in total leads to a more durable worm drive and to an increased useful life. If need be, the adjustment drive can take up a smaller installation space due to the use of smaller worm gears when the gear ratio is constant.

According to a preferred embodiment of the invention, the worm gears are not only torque-transmittingly coupled to the gearing worm but are even additionally coupled to each other. It thereby lies within the scope of the invention to arrange the worm gears to directly intermesh with each other or to torque-transmittingly connect the worm gears to each other via at least one additional, rotationally arranged drive element. In such an embodiment with worm gears, which are torque-transmittingly coupled to each other, the second worm gear is more or less powerless during normal operation, i.e. essentially transmitting no torque, is carried along. If, however, the first worm gear experiences an overload, for example during a blocking operation or from static constant loads, for example in the case of a window situated at the limit stop, an auxiliary force flow is transmitted via the torque-transmitting coupling of the two worm gears onto the gearing worm, respectively from the gearing worm onto the second worm gear. Particularly in the case of worm gears, which are configured from plastic and preferably one-pieced, the torque during normal operation is transmitted at least approximately solely by the gearing worm onto the first worm gear and from there further onward, for example onto a cable pull mechanism. If an overload of the first worm gear occurs, i.e. the gearing forces between the gearing worm and the first worm gear exceed a certain level, preferably a deformation of the first worm gear initially results. The transmission of torque from the gearing worm is then distributed onto the two worm gears by means of the torque-transmitting coupling between the two worm gears, whereby the force on the first worm gear is limited. In total a larger torque can be transmitted via the configuration of at least the two worm gears. The adjustment of the play in the gearings of the adjustment drive therefore becomes very important. The adjustment establishes how much (how greatly) the first worm gear deforms before the second worm gear participates in the transmission of force. The play in the gearings should be adjusted in such a way that the second worm gear already participates in the torque transmission, when the first worm gear is still located in the elastic deformation range.

Provision is advantageously made in a modification of the invention for the worm gears to be directly enmeshed with each other. For this purpose, both worm gears have respectively at least one ring gear, the ring gears of the worm gears intermeshing with clearance to the gearing worm. The ring gears are preferably disposed directly beside the section of the respective worm gear, which is situated in mesh with the gearing worm and is preferably helical.

Provision is advantageously made in a modification of the invention for the worm gears, especially those manufactured from plastic, for example, by injection molding or die casting, to have intermeshing ring gears with straight-cut gear teeth, i.e. equipped with teeth, which are circumferentially adjacent and which extend parallel to the axis of rotation of the respective worm gear.

An arrangement of the worm gears is particularly advantageous, wherein the worm gears are situated on opposite longitudinal sides of the gearing worm and are in mesh with said gearing worm on said opposite longitudinal sides. It is thereby advantageous for the axes of rotation of the worm gears to run parallel to each other, i.e. they are laterally disposed to the longitudinal extension of the gearing worm.

A predominantly even torque distribution can be advantageously achieved between at least the two worm gears, if they lie exactly opposite each other, i.e. the axes of rotation of the worm gears vertically cut an imaginary axis, which likewise cuts the longitudinal axis of the gearing worm at right angles.

In a most simple form of embodiment, only one of the at least two worm gears is equipped with an output element for the retransmission of the torque, for example onto a cable pull mechanism. The output element can, for example, be configured as a knurled section or as a ring gear. It is especially preferable if the output element of the first worm gear is disposed adjacent to the section of the worm gear, which is situated in mesh with the gearing worm, preferably on the side opposite to the ring gear, with which the first worm gear meshes with the ring gear of the second worm gear.

In a modification of the invention, provision is made for at least a second output element, which is assigned to the second worm gear in addition to the first output element, which is assigned to the first worm gear. In so doing, the adjustment drive has in total at least two power outputs.

It is particularly preferred if the output elements together torque-transmittingly engage with an additional drive component, particularly with a gear rack, the additional drive component being driven by both output elements, i.e. simultaneously, so as to essentially cut the load on the individual worm gears in half. With regard to such an embodiment of the adjustment drive, a direct engagement of the gearing of the worm gears can if necessary be avoided. The worm gears are thus configured without additional ring gears.

For reasons of cost and to simplify the installation, an embodiment is advantageous, wherein the two worm gears are identically configured. Preferably such an embodiment deals with plastic worm gears.

### BRIEF DESCRIPTION OF THE DRAWINGS

Additional advantages, characteristics and details of the invention are apparent in the following description of preferable examples of embodiment as well as with the aid of the drawings. They show in:

FIG. 1 is a perspective depiction of an adjustment drive with two worm gears, which intermesh with a gearing worm and lie opposite each other;

FIG. 2 is a complementary sectional view along the intersection lines A—A according to FIG. 1; and

FIG. 3 a schematic depiction of an adjustment drive, wherein the two worm gears are jointly disposed in mesh with the gearing worm as well as with a gear rack.

### DETAILED DESCRIPTION

Identical components and components with the same function are denoted with the same reference numerals in the figures.

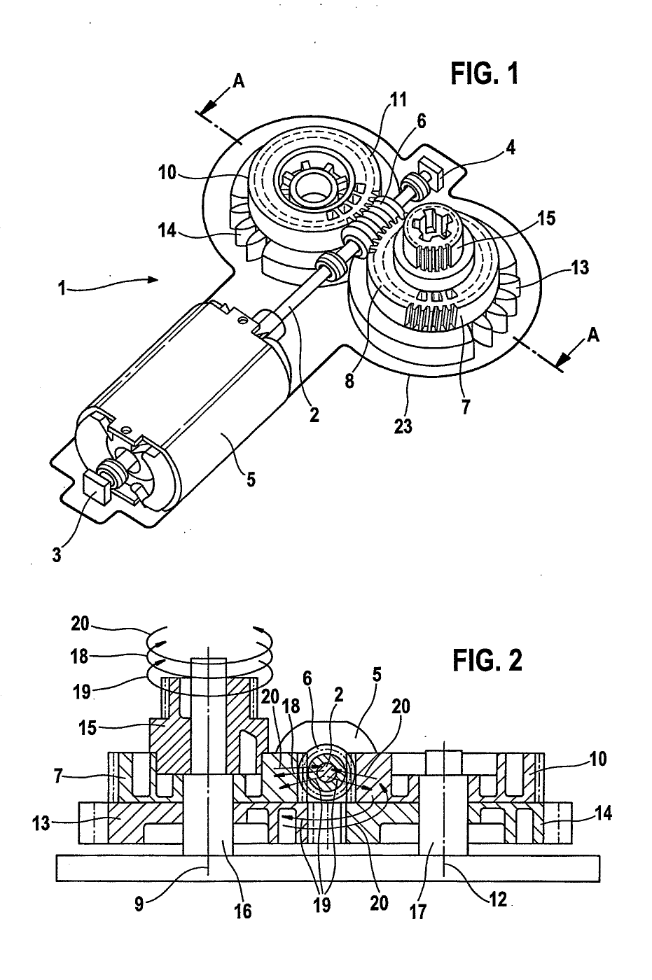

In FIG. 1, a simple embodiment of an adjustment drive 1 for adjusting a window in a motor vehicle is depicted. A rotationally arranged output shaft 2, which is disposed between two axial limit stops 3, 4 spaced apart from each other, is to be seen. A gearing worm 6 made of metal, in this example made of brass, sits on the output shaft 2 driven by an electric motor 5.

The gearing worm 6 meshes with a first worm gear 7 out of plastic, more precisely with a helical first section of engagement 8 of the first worm gear 7. The first axis of rotation 9 of the first worm gear 7, which is marked in FIG. 2, then runs at a given distance from and vertically to the longitudinal extension of the output shaft 2.

A second worm gear 10 is disposed on the longitudinal side of the output shaft 2, respectively the gearing worm 6, which lies opposite to the first worm gear 7. Said second worm gear 10 likewise meshes via a second helical section of engagement 11 with the gearing worm 6. The second axis of rotation 12 of the second worm gear 10, which is seen in FIG. 2, runs parallel to the first axis of rotation 9 of the first worm gear 7 and is disposed the same distance away from the gearing worm 6 as the first axis of rotation 9. Both axes of rotation 9, 12 are cut at right angles by an imaginary, unspecified axis, which cuts the gearing worm 6 in a lateral direction.

As it is made apparent particularly in FIG. 1, the first, worm gear 7, which is configured as one piece, is equipped with a first ring gear 13 with straight-cut gear teeth lying adjacent to the first section of engagement 8. Said first ring gear 13 torque-transmittingly engages with an identical second ring gear 14 of the second worm gear 10.

As it is made apparent in FIGS. 1 and 2, a first output element 15, which is configured as a gearing element, is disposed adjacent to the first section of engagement 8 of the first worm gear 7. Said first output element 15 serves to drive an unspecified window lift mechanism, which is inherently known. A possible peripheral contour of an adjustment drive housing is indicated in FIG. 1 with the reference numeral 23.

As can be seen in FIG. 2, the first worm gear 7 is rotationally arranged on a first pin 16 and the second worm gear 10 on a second pin 17.

The torque flows under different load conditions of the adjustment drive are shown in FIG. 2 by different arrows. The arrows denoted with the reference numeral 18 thereby show the torque flow under the normal adjustment condition. It is to be noted that a transmission of torque essentially takes place only between the gearing worm 6 and the first worm gear 7. The arrows denoted with the reference numeral 19 show the torque flow in the stop state, i.e. when a gear tooth deformation of the first worm gear 7 starts. It is to be noted that a transmission of torque takes place between the gearing worm 6 and the first worm gear 7 as well as between the gearing worm 6 and the second worm gear 10; and in so doing, the torque of the second worm gear 10 and the second ring gear 14 are retransmitted to the first ring gear 13 and thereby to the first worm gear 7, respectively the output element 15.

The arrows denoted with the reference number 20 show the torque flow when the adjustment drive is being stressed from the drive side during a so-called creep test. It is to be noted that the arrows 20 are thereby arranged opposite to the arrows 19.

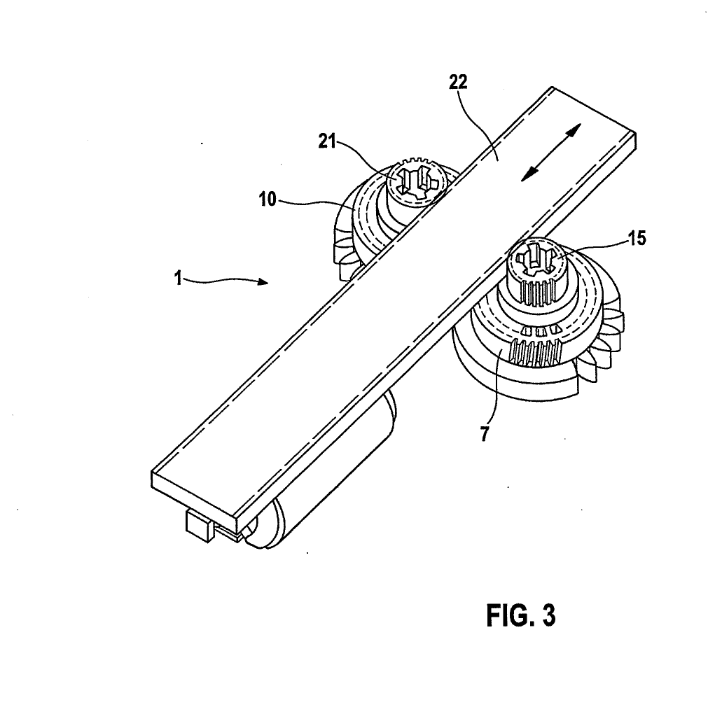

An alternative example of embodiment of an adjustment drive 1 is shown in FIG. 3. In order to avoid repetition, essentially only the differences to the examples of embodiment shown in FIGS. 1 and 2 are described below. As a result of the common subject matter, reference is made to the preceding description of the figures as well as to the associated FIGS. 1 and 2. It is to be noted that the second worm gear 10 in contrast to the second worm gear 10 according to the previously described example of embodiment has a second output element 21, which is identically configured as the first output element 15 of the first worm gear 7.

Both output elements 15, 21 torque-transmittingly engage with a gear rack 22, which is schematically indicated. The torque flow in such a configuration already distributes itself from the gearing worm 6 to both of the worm gears 7, 10 and is transmitted via the output elements 15, 21 to the gear rack 22 evenly distributed on two opposite sides. Comparatively large torques can be transferred with an adjustment drive configured in such a way. A gear rack with a round cross-section can also be employed instead of the gear rack shown with a rectangular cross-section.

1. An adjustment drive, especially a window actuating drive in a motor vehicle, with a gearing worm capable of being driven by an electric motor, comprising:
a first worm gear engaging with the gearing worm; and
a second worm gear situated in mesh with the gearing worm.

2. The adjustment drive of claim 1, wherein the first worm gear and the second worm gear are torque-transmittingly coupled to each other.

3. The adjustment drive of claim 2, wherein the first worm gear and the second worm gear have in each case a ring gear, and wherein each respective ring gear is disposed at a given distance from the gearing worm so that they intermesh.

4. The adjustment drive of claim 3, wherein the first worm gear and the second worm gear in each case have a gearing with a plurality of straight-cut gear teeth.

5. The adjustment drive of claim 1, wherein the first worm gear and the second worm gear are situated in mesh with the gearing worm on two opposite longitudinal sides of said gearing worm, and wherein an axes of rotation of the worm gears run parallel to each other.

6. The adjustment drive of claim 5, wherein an axes of rotation of the first and second worm gears are cut at a right angle by an imaginary axis that runs laterally to the longitudinal axis of the gearing worm.

7. The adjustment drive of claim 1, further comprising a first output element, preferably a first gearing section, at the first worm gear.

8. The adjustment drive of claim 7, further comprising a second output element, preferably a second gearing section, at the second worm gear.

9. The adjustment drive of claim 8, thereby characterized, wherein the first output element and the second output element are disposed to drive a gear rack.

10. The adjustment drive of claim 1, wherein the first worm gear and the second worm gear are identically configured, and wherein the first worm gear and the second worm gear are preferably a plastic component.
